(19) United States
(12) Patent Application Publication
(10) Pub. No.: US 2008/0235199 A1
(43) Pub. Date: Sep. 25, 2008

(54) NATURAL LANGUAGE QUERY INTERFACE, SYSTEMS, AND METHODS FOR A DATABASE

(76) Inventors: Yunyao Li, Menands, NY (US); H. V. Jagadish, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 11/687,917

(22) Filed: Mar. 19, 2007

(51) Int. Cl. G06F 17/30

(52) U.S. Cl. 707/4

(57) ABSTRACT

A method for translating a natural language query into a structured query for a database is provided. The method generally includes: generating a parse tree which represents a natural language query for a database; mapping terms in the parse tree to components of a structured query language for the database; and grouping the components of the structured query language.

### FIELD

The present disclosure relates to methods and systems for querying stored information using a natural language query.

### BACKGROUND

The statements in this section merely provide background information related to the present disclosure and may not constitute prior art.

In the real world, information is obtained by asking questions in a natural language, such as English. Recent trends in database query systems aspire to support such arbitrary natural language queries. However, two major obstacles have prevented effective support for arbitrary natural language queries. First, automatically understanding natural language is itself still an open research problem, both semantically and syntactically. Second, even if any natural language query could be fully understood, translating the natural language query into a correct formal query remains an issue. For example, the translation would require mapping the understanding of intent into a specific database schema. Thus, the need exists for a database query system and method that effectively supports a natural language query.

### SUMMARY

Accordingly, a method for translating a natural language query into a structured query for a database is provided. The method generally includes: receiving a parse tree which represents a natural language query for a database; mapping terms in the parse tree to components of a structured query language for the database; and grouping the components of the structured query language.

In other features, a computer program product for performing natural language queries of a database is provided. The computer program product includes a computer readable medium. The computer readable medium generally includes a parser that is operable to generate a parse tree which represents a natural language query for the database. A classifier is operable to map terms in the parse tree to components of a structured query language for the database. A translator is operable to group the components of the structured query language.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram illustrating one embodiment of a natural language query system according to various aspects of the present disclosure.

FIG. 2 is an exemplary query user interface of the natural language query system according to various aspects of the present disclosure.

FIG. 3 is a tree diagram illustrating an exemplary parse tree generated by the natural language query system according to various aspects of the present disclosure.

FIG. 4 is a tree diagram illustrating an exemplary classified parse tree generated by the natural language query system according to various aspects of the present disclosure.

FIG. 5 depicts an exemplary data structure for a transformation rule generated by the natural language query system according to various aspects of the present disclosure.

FIG. 6 is a process flow diagram illustrating an exemplary translation method that can be performed by the natural language query system according to various aspects of the present disclosure.

FIG. 7 is a table listing exemplary variable bindings that can be generated by the natural language query system according to various aspects of the present disclosure.

FIG. 8 is a table listing exemplary direct mapping that can be generated by the natural language query system according to various aspects of the present disclosure.

FIG. 9 is a table listing program code for one embodiment of a grouping and nesting determination that can be generated by the natural language query system according to various aspects of the present disclosure.

FIG. 10 is a table listing exemplary updated variable bindings that can be generated by the natural language query system according to various aspects of the present disclosure.

FIG. 11 is a table listing an exemplary structured language query that can be generated by the natural language query system according to various aspects of the present disclosure.

FIG. 12 is a table listing exemplary iterative natural language queries that can be processed by the natural language query system according to various aspects of the present disclosure.

FIG. 13 is a process flow diagram illustrating an exemplary translation method for iterative searches that can be performed by the natural language query system according to various aspects of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

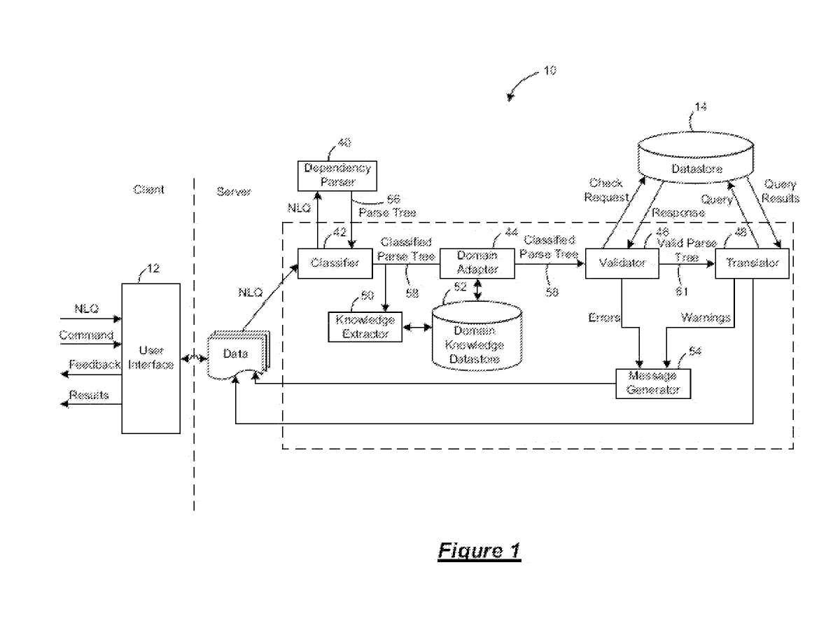

With reference to FIG. 1, a block diagram illustrates a natural language query system 10 according to various aspects of the present disclosure. In general, a user enters a natural language query (NLQ) via a query user interface 12. The natural language query system 10 receives the NLQ, translates the terms of NLQ into a structured language query, and performs a query on information stored in a datastore 14 based on the structured language query. The natural language query system 10 reports results of the query as well as any feedback information, such as error or warning messages, to the user via the query user interface 12.

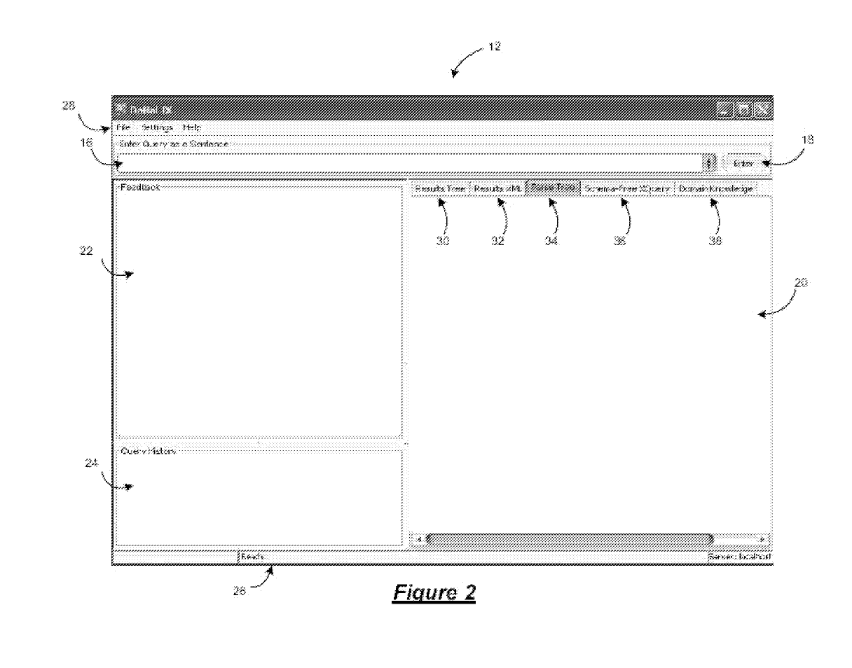

An exemplary query user interface 12 is shown in FIG. 2. The exemplary query user interface 12 includes a query entry text box 16, a query execution button 18, a results display 20, a feedback display 22, a query history display 24, a status display 26, and a toolbar 28. The query entry text box 16 accepts text input indicating the NLQ. The query execution button 18, when selected, activates the execution of one or more query functions of the natural language query system 10 based on the NLQ entered in the query entry text box 16. Results of the one or more query functions are displayed in the results display 20. The results display 20 can include one or more tab displays 30-38 that, when selected, display particular data results for the particular functions. For example, the results display 20 can include a results tree tab 30, a results XML tab 32, a parse tree tab 34, a schema-free XQuery tab 36, and a domain knowledge tab 38. The data results for each tab display 30-38 will be discussed further below.

The feedback display 22 can display query feedback information generated by the one or more query functions. As can be appreciated, the feedback information can be displayed in a statement and/or a user interactive format (i.e., generated question with selectable responses). The query history display 24 can display a listing of all the NLQs entered in the query entry text box 16. The status display 26 can display a current status of the functions of the query such as, but not limited to, “ready,” “encountered a problem parsing the query,” and “query results successfully loaded.” The toolbar 28 can include one or more menus that provide storage and retrieval options, provide formatting information, and/or provide help information.

For exemplary purposes, the remainder of the disclosure will be discussed in the context of the following exemplary NLQ entered by the user in the query entry text box 16:
“Return every director, where the number of movies directed by the director is the same as the number of movies directed by Ron Howard.”

Referring back to FIG. 1, in one example, the natural language query system 10 includes a dependency parser 40, a classifier 42, a domain adapter 44, a validator 46, a translator 48, a knowledge extractor 50, a domain knowledge datastore 52, and a message generator 54. As can be appreciated, the functionality of the individual components of the natural language query system 10 can be combined and/or further partitioned to similarly perform queries on information stored in the datastore 14.

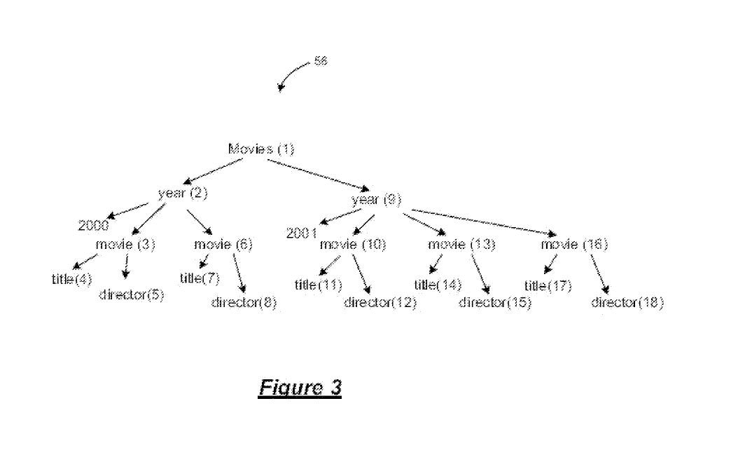

In various aspects, the classifier 42 receives as input the NLQ. Based on the NLQ, the classifier 42 obtains a dependency parse tree 56 from the dependency parser 40. As can be appreciated, the dependency parser 40 generates the dependency parse tree 56 based on natural language parse methods as known in the art. FIG. 3 illustrates an exemplary parse tree 56 that can be generated by the dependency parser 40. The parse tree 56, as shown, is generated based on the exemplary NLQ discussed above. In particular, each term in the exemplary NLQ is listed as part of a tree structure based on a predetermined grammar that relies on a relationship between terms.

Referring back to FIG. 1, the classifier 42 then identifies terms and/or phrases in the parse tree 56 that can be mapped into query components. Each such term and/or phrase is referred to as a token. A term or phrase that does not match any query component is referred to as a marker. The classifier 42 can then further classify the tokens and markers into types based on their potential semantic contributions in the query translation. Exemplary tokens types can include, but are not limited to, a command token (CMT), an order by token (OBT), a function token (FT), an operator token (OT), a value token (VT), a name token (NT), a negation token (NEG), a quantifier token (QT), and a reference token (RT). Exemplary token types for a structured query language such as Extensible Markup Language (XML) and their respective definitions are listed in the table of Appendix A. Exemplary marker types can include, but are not limited to, a connection marker (CM), a modifier marker (MM), a pronoun marker (PM), a general marker (GM), and a substitution marker (SM). Exemplary marker types for a structured query language such as XML and their respective definitions are listed in the table of Appendix B.

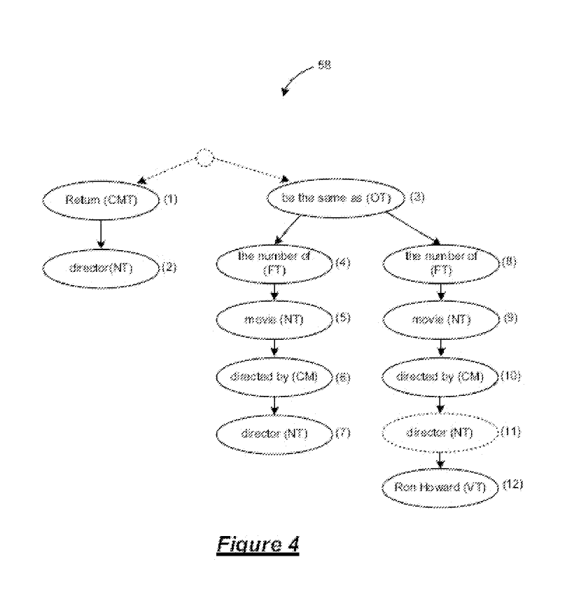

Based on the identification of the tokens and markers, the classifier 42 generates a classified parse tree 58. FIG. 4 illustrates an exemplary classified parse tree 58 that can be generated by the classifier 42 (FIG. 1). The classified parse tree 58, as shown, is generated based on the exemplary parse tree 56 shown in FIG. 3 and the exemplary NLQ as discussed above. The classified parse tree 58 includes a plurality of nodes, one for each term, and labeled according to the marker type or token type. Each node is assigned a unique identifier. Note that director (NT) node 11 is not in the exemplary NLQ. Rather, the node is an implicit node that has been inserted by the classifier 42 (FIG. 1) based on an implicit name token definition (see, e.g., Appendix G). Note that in some cases some terms in the NLQ may not be able to be classified into either a token or a marker. Such unclassified terms cannot be properly mapped into a structured query language. As will be discussed further below, the validator 46 (FIG. 1) can report the non-classification to the user via the query user interface 12 during parse tree validation.

Referring back to FIG. 1, the domain adapter 44 receives as input the classified parse tree 58. The domain adapter 44 incorporates domain knowledge from the domain knowledge datastore 52 into the classified parse tree 58. If the domain knowledge datastore 52 contains no domain knowledge, the domain adapter 44 simply passes the classified parse tree 58 to the validator 46. Otherwise, if applicable domain knowledge is found, the domain adapter 44 utilizes this knowledge to transform the classified parse tree 58.

More particularly, the knowledge extractor 50 can actively learn new domain knowledge based on interactions between users and the natural language query system 10. Provided a high volume of user traffic on the natural language query system 10, the domain knowledge datastore 52 can be fully populated with learned domain knowledge within a short period of time. The knowledge extractor 50 employs a simple term mapping form which expresses domain-specific knowledge in generic terms, over complex semantic logical forms such as lambda-calculus. In particular, domain knowledge is represented as a set of transformation rules that can be used to transform a classified parse tree 58 that includes terms with domain-specific semantics into one that does not. The validator 46 and the translator 48 can then operate on the transformed classified parse tree 58 using only domain-independent knowledge.

In various aspects, each transformation rule of the set of transformation rules includes a source tree and a target tree. The source tree and the target tree for each transformation rule are semantically equivalent. However, the source tree includes terms with domain-specific meanings, while the target tree includes generic terms and/or domain-specific terms already available in the domain knowledge datastore 52. Additionally, each transformation rule includes a confidence score that can be used to establish priority among rules during knowledge incorporation (as will be discussed in more detail below).

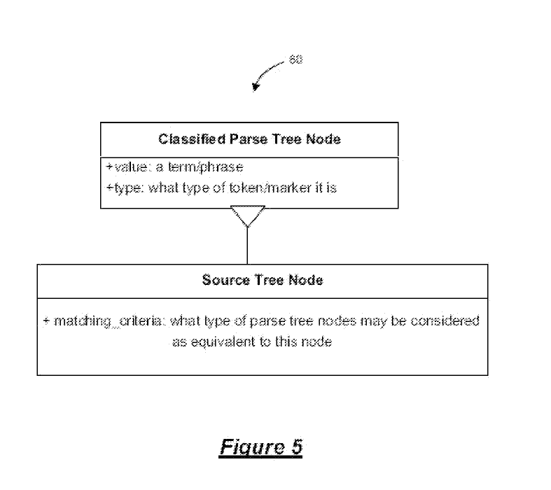

FIG. 5 depicts an exemplary data structure for a transformation rule 60 that can be associated with a particular source tree node. Similar to the nodes in the classified parse tree 58 (FIG. 4) generated by the classifier 42 (FIG. 1), nodes in the source tree of the transformation rule 60 have both values and types. In addition, the transformation rule 60 for a source tree node includes information indicating how the node should be matched during transformation, denoted as matching criteria. Each node is assigned a default matching criteria value based on the node type and a position in the tree. For example, the default matching criteria value for a root node in the transformation rule is “match by type.” Meanwhile, the default matching criteria value for any other node in the source tree is “match by value,” unless the node is of certain types.

Referring back to FIG. 1, the knowledge extractor 50 learns new transformation rules 60 (FIG. 5) based on the source tree and the target tree. The knowledge extractor 50 learns the transformation rule 60 (FIG. 5) by recursively traversing in parallel the source tree and the target tree, starting from the root nodes. Two nodes, one from each tree, are compared and considered equivalent if their parent nodes are equivalent and each of their corresponding children nodes have the same type and value. If two nodes, one from each tree, are compared and found to be not equivalent, a new transformation rule 60 (FIG. 5) is created for the two nodes and any children nodes. The creation of the rule does not stop until two nodes with identical types, values, and subtrees or the entire parse tree has been traversed. As can be appreciated, multiple transformation rules 60 (FIG. 5) may be found for a given pair of parse trees.

The method as discussed above requires the pair of parse trees to be semantically equivalent to be able to extract meaningful domain knowledge. In various aspects, whenever a user query is successfully processed without requiring any reformulation, it can be compared against a recent query history to find similar queries based on the parse trees. The parse tree most similar to the current query can be chosen as a possible equivalent query. The knowledge extractor 50 can prompt the user to confirm whether the two queries indeed correspond to the same semantics. If the user confirms the equivalence, the knowledge extractor 50 can then use the pair of parse trees to build a new transformation rule 60 (FIG. 5).

In addition to learning from individual pairs of queries, the knowledge extractor 50 can incrementally make refinements to the transformation rules 60 (FIG. 5) stored in the domain knowledge datastore 52 by changing the matching criteria for nodes in the existing transformation rules 60 (FIG. 5) based on the statistics of the rule collection. For example, multiple transformation rules 60 (FIG. 5) may found to be identical except for a value at a single node. If the number of such rules passes a chosen threshold, the knowledge extractor 50 can infer that the value is not important to the semantics of the transformation rule 60 (FIG. 5). The transformation rules 60 (FIG. 5) can then be merged into one, with the matching criteria of that node changed from “match by value” to “match by type,” resulting in a more general rule.

Similarly, in various aspects, the knowledge extractor 50 can alter a transformation rule 60 (FIG. 5) to be more restrictive. For example, a transformation rule 60 (FIG. 5) may include a node that originally allows “match by value.” If a conflicting transformation rule 60 (FIG. 5) is found in the domain knowledge datastore 52, where the two transformation rules 60 (FIG. 5) have different target trees but identical source trees except for the value of a node. The matching criteria of the node can be changed to require more restrictive matching such as “match by value.” In various aspects, finer granularity of matching criteria values is also possible given a domain ontology.

The domain adapter 44 then uses the transformation rules 60 (FIG. 5) to transform the classified parse tree 58. The domain adapter 44 begins by traversing the classified parse tree 58 until a portion of the tree that matches the source tree specified in the transformation rule 60 (FIG. 5) (based on the matching criteria of the source tree nodes) is found. The domain adapter 44 then replaces this portion of the classified parse tree 58 with the target tree specified by the transformation rule 60 (FIG. 5).

More than one transformation rule 60 (FIG. 5) in the domain knowledge datastore 52 may be found to be applicable to a particular classified parse tree 58. An appropriate transformation rule 60 (FIG. 5) is selected via user feedback. For example, when a user submits a NLQ, it is first transformed using the transformation rule 60 (FIG. 5) of the highest confidence score among all the applicable transformation rules 60 (FIG. 5). The natural language query system 10 then informs the user about this transformation and provides to the user an option of rejecting the transformation rule 60 (FIG. 5), or processing the query with another suitable transformation rule 60 (FIG. 5). The confidence score of the transformation rule 60 (FIG. 5) will be decreased for rejections or increased for selections. If the user does not reject the transformation rule 60 (FIG. 5) or attempt to rephrase the NLQ, the lack of response can be then considered as a selection to the transformation rule 60 (FIG. 5) currently used by the natural language query system 10. Transformation rules 60 (FIG. 5) with sufficiently low confidence may be eliminated from the domain knowledge datastore 52. In various aspects, the various applicable transformation rules 60 (FIG. 5) can be displayed in the domain knowledge tab 38 (FIG. 2). The user may then view and select an alternate transformation rule 60 (FIG. 5).

The validator 46 receives as input the classified parse tree 58 that may or may not have been transformed. The classified parse tree 58, even after transformation based on domain knowledge, may still contain terms that are not understood by the natural language query system 10. The validator 46 determines whether the classified parse tree 58 is one that the natural language query system 10 knows how to map into a structured query language. The validator 46 can also initiate a check request to verify whether the element/attribute names and/or values of the nodes in the classified parse tree 58 can be found in the datastore 14. If a classified parse tree 58 is found to be invalid, information about the errors is sent to the message generator 54 and a feedback message is generated to the user via the query user interface 12. Otherwise, a valid parse tree 61 is passed to the translator 48.

More particularly, the validator 46 aggregates tokens in the classified parse tree 58 slightly from their lowest unit of identification to create tokenization suitable for efficient validation. For example, the validator 46 applies a parse tree normalization process that recursively rewrites the classified parse tree 58 based on normalization definitions. Exemplary normalization definitions can be found in Appendix C.

After normalization, validation is performed on the normalized parse tree. If validation fails, error information is generated. More particularly, the validator 46 validates the normalized parse tree based on a grammar associated with the structured query language. The table in Appendix D lists an exemplary grammar that can be supported by a structured query language such as XML that is derived from XML query semantics. The validator 46 generates error and/or warning information based on validation rules and/or conditions. Exemplary validation rules and conditions can be found in Appendix E. Exemplary error and/or warning information can be found in Appendix F. The NLQ can be iteratively adjusted based on the error and warning information and the classified parse tree 58 can be updated accordingly. The iterative process is performed until the valid parse tree 61 is generated.

The translator 48 receives as input the valid parse tree 61. The translator 48 translates the valid parse tree 61 into a structured language query 63. The translator 48 performs a query on the datastore 14 based on the structured language query 63. The translator 48 passes the results from the query to the query user interface 12 for viewing by the user. In one example, the translator 48 translates the valid parse tree 61 into an XML query, also referred to as an XQuery, for querying an XML database. The translator 48 translates the valid parse tree into an XQuery based on translation definitions. Such definitions can include, but are not limited to, the definitions listed in Appendix G.

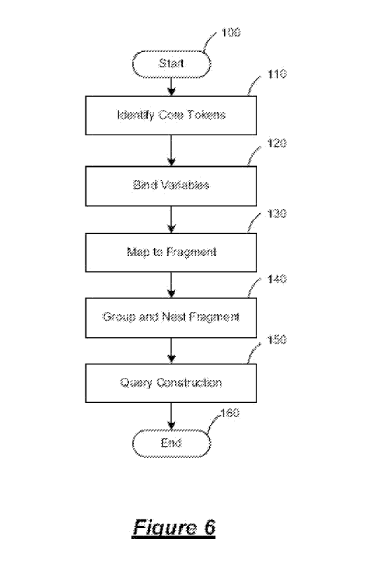

Provided the conceptual definitions, the translator 48 maps each token in the valid parse tree 61 into a query fragment and associates or groups the query fragments to form the structured language query 63. An exemplary translation method is shown in FIG. 6. Each step of the method will be illustrated in the context of the exemplary NLQ discussed above.

In one example, the method may begin at 100. Core tokens are identified at 110. In various aspects, core tokens in the valid parse tree are identified according to Definition 3 of Appendix G. For example, two different core tokens can be found in the exemplary NLQ query. The first is “director,” represented by nodes 2 and 7. The second is a “director,” represented by node 11. Note although node 11 and nodes 2, 7 are composed of the same term, they are regarded as different core tokens, as node 11 is an implicit NT, while nodes 2, 7 are not.

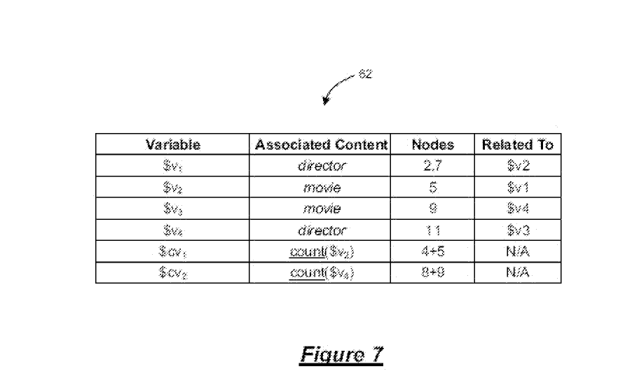

At 120, variable binding occurs. More particularly, each name token (NT) of the valid parse tree 61 (FIG. 1) is bound to a variable. Such variable binding can be denoted as: [symbol] var [symbol] →NT. Two name tokens can be bound to different basic variables, unless they are regarded as the same core token or identical. In various aspects, the name tokens can be regarded as identical based on Definitions 8, 9, and 10 of Appendix G. Patterns such as, [symbol] FT+NT [symbol] | [symbol] FT₁+FT₂+NT [symbol] , can also be bound to variables. Variables bound with such patterns are referred to as composed variable, denoted as: [symbol] cmp var [symbol] , to distinguish from the basic variables bound to NTs. Such variable binding can be denoted as:
[symbol] function [symbol] →FT, and
[symbol] cmp var [symbol] →( [symbol] function [symbol] + [symbol] var [symbol] )|( [symbol] function [symbol] + [symbol] cmp var [symbol] ).
   The table of FIG. 7 shows the variable bindings for the exemplary NLQ and based on the exemplary classified parse tree 58 shown in FIG. 4.

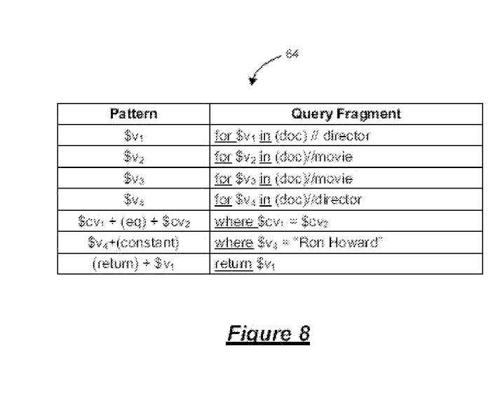

At 130 of FIG. 6, mapping of patterns and tokens into query fragments occurs. For example, certain patterns of tokens can be mapped directly into query fragments. Exemplary mapping rules and corresponding query fragments can be found in Appendix H. As can be appreciated, Appendix H illustrates the mapping rules in an XML format. Hereinafter, the structural query language used is XML. As can be appreciated, other structured query languages are similarly applicable. The table in FIG. 8, shows an exemplary list of direct mappings from token patterns to XML query fragments 64 for the exemplary NLQ and based on the exemplary classified parse tree 58 shown in FIG. 4.

At 140 of FIG. 6, grouping and nesting of the query fragments 64 obtained in the mapping process occurs. Grouping and nesting is typically performed when the NLQ includes function tokens which correspond to aggregation functions or when the NLQ includes quantifier tokens which correspond to quantifiers. Grouping and nesting is performed based on grouping transformation rules and mapping rules. Exemplary transformation rules and mapping rules for XML queries can be found in Appendix I.

More particularly, with regard to the aggregation functions, two different nesting scopes (inner and outer) are identified with respect to the basic variable that the aggregation function directly attaches to. The nesting scope of the LET fragment corresponding to the aggregation function depends on the basic variable. If an aggregation function attaches to a basic variable that represents a core token, then all the fragments containing variables related to the core token should be placed inside the LET fragment of this function. Otherwise, the relationships between name tokens (represented by variables) via the core token will be lost.

For example, given the query “Return the total number of movies, where the director of each movie is Ron Howard,” the only core token is movie. Clearly, the condition clause “where $dir=‘Ron Howard’” should be bound with each movie inside the LET clause. Therefore, the nesting scope of a LET clause corresponding to the core token is marked as inner with respect to the variable (in this case $movie). On the other hand, if an aggregation function attaches to a basic variable representing a non-core token, only clauses containing variables directly related to the variable should be placed inside of the LET clause. The nesting scope of the LET clause should be marked as outer, with respect to the variable. Similarly, when there are no core tokens, the variable may only be associated with other variables indirectly related to the variables via value joins. The nesting scope of the LET clause should also be marked as outer.

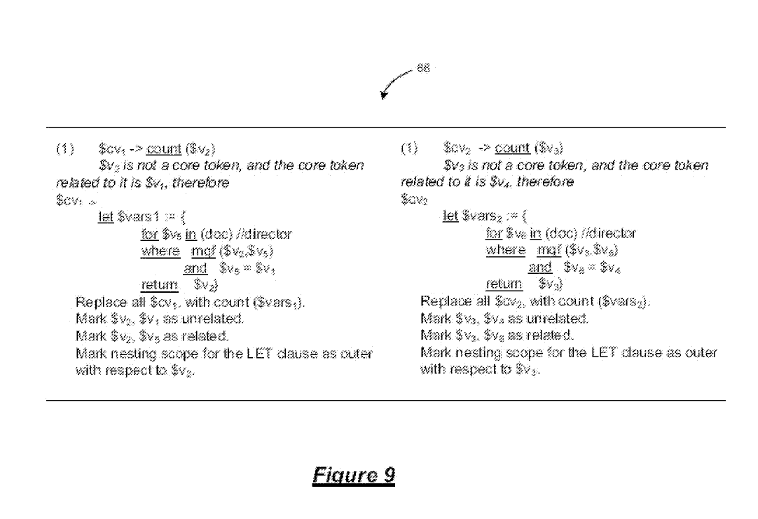

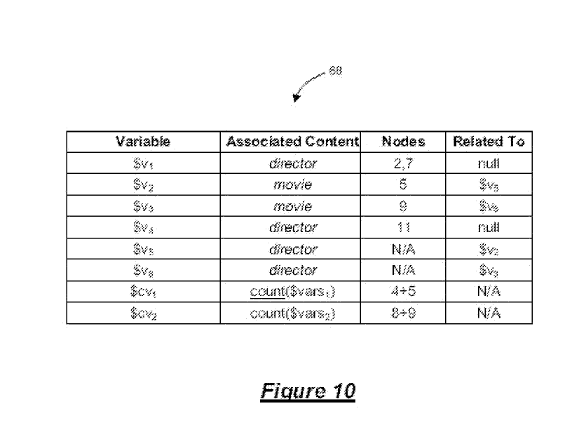

With regard to the quantifiers, the nesting scope determination is similar to that for an aggregation function, except that the nesting scope is now associated with a quantifier inside a WHERE clause. When the variable is a core token, the nesting scope of a quantifier is marked as inner with respect to the variable. Otherwise, the nesting scope is marked as outer with respect to the variable. The meanings of inner and outer are the same as for the aggregation functions, except that now only WHERE clauses may be placed inside a quantifier. The table in FIG. 9 shows an exemplary grouping and nesting determination 66 based on the exemplary classified parse tree 58 shown in FIG. 4. The updated variable bindings and relationships 68 between basic variables for the exemplary NLQ can be found in the table of FIG. 10.

With reference back to FIG. 6, at 150, a full query construction occurs. For example, the query can be constructed by starting from an innermost query fragment and working outwards. If the scope defined is inner with respect to the variable, then all other query fragments containing the variable or basic variables related to the variable are placed within an inner query following the FLOWR convention (e.g., conditions in WHERE clauses are connected by and) as part of the query at the outer level. If the scope defined is outer with respect to the variable, then only query fragments containing the variable, and fragments (in the case of a quantifier, only WHERE clauses) containing basic variables directly related to the variable are placed inside the inner query, while query fragments of other basic variables indirectly related to the variable are placed outside of the fragment at the same level of nesting. The remaining query fragments are placed in an appropriate place at the outmost level of the query following the FLOWR convention.

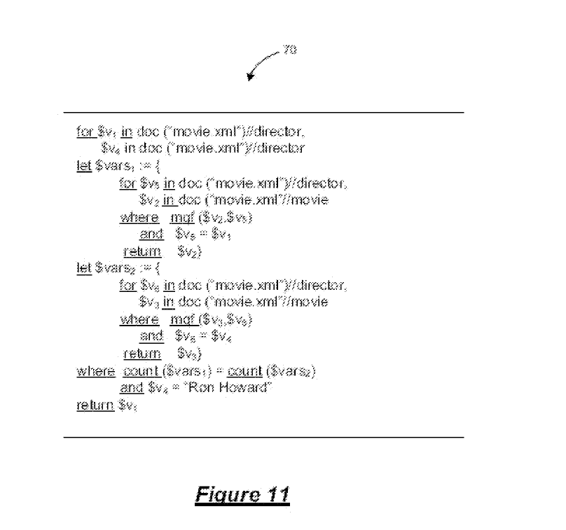

A full query construction 70 for the exemplary NQL can be found in FIG. 11. As shown in FIG. 11, the document variable [symbol] doc [symbol] is replaced by the name of the actual database in use, either specified in the query, or chosen by the user beforehand from a list of available databases. Thereafter, the translation is complete and the method may end at 160 of FIG. 6.

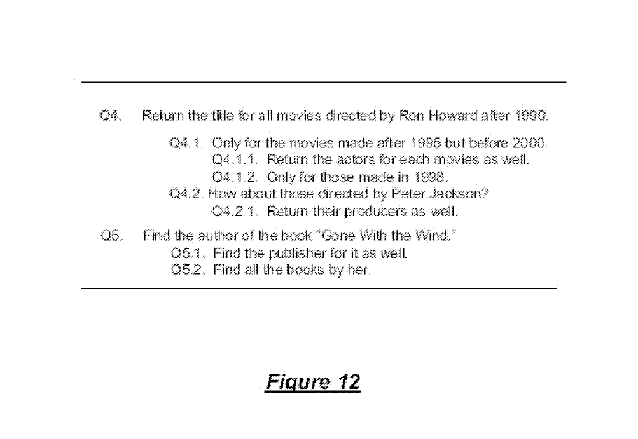

Referring back to FIG. 1, after a first query has been performed and results displayed, the natural language query system 10 can accept additional NLQ information from the user to further refine the query. To perform an iterative query, the natural language query system 10 constructs a query tree. Each query tree includes multiple NLQs on a single topic or multiple related topics. The root of a query tree is the first NLQ submitted by the user to initiate a query regarding a specific topic. The query tree then expands as the user submits new NLQs to refine existing NLQs in the query tree. When the user submits a follow-up NLQ to an existing NLQ, the existing NLQ is labeled as the root query or the parent query (Qp) in the query tree, and the subsequent NLQs are labeled as child queries (Qc). FIG. 12 illustrates exemplary NLQs that can be entered by a user. The parent query is shown as, for example, NLQ 4 (Q4) and NLQ 5 (Q5) in FIG. 12. The child queries are shown as, for example, NLQ 4.1 (Q4.1) and NLQ 4.1.1 (Q4.1.1) in FIG. 12.

Referring back to FIG. 1, each component of the natural language query system 10 processes the child queries as discussed above with only a few distinctions. For example, the classifier 42 identifies terms and/or phrases in the original NLQ that can be mapped into corresponding query components as described above. In addition, the classifier 42 identifies in the classified parse tree 58 terms and/or phrases that represent references to the parent or prior child queries. The validator 46 validates the classified parse tree 58 as discussed above. However, in various aspects, if the child query leads to the same or similar warning message as presented with respect to the parent query, the warning message is suppressed. This is based on the assumption that if a user has already chosen to ignore the warning message (by typing a new query causing the same warning), then the same warning message is likely to be ignored again.

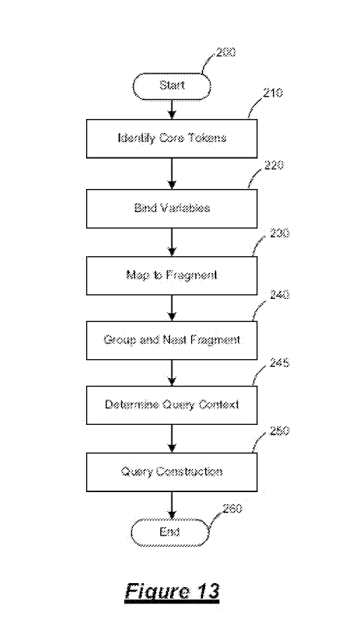

The translator 48 similarly translates the query fragments into a structured language query 63 based on the translation method as discussed above with a few distinctions. An exemplary translation method for a child query is shown in FIG. 13. For example, the method may begin at 200. Core token identification and variable binding for a child query are performed at 210 and 220 respectively and are essentially the same as that for a parent query, with the following key difference. A noun token NTc in a follow-up query is bound to a new basic variable, unless it is regarded as identical to a noun token NTp in the inherited query context. In such a case, the noun token NTp is called an inherited noun token of NTp and is assigned to the same variable as NTp (say, $vp). The list of related variables for $vp is also updated based on the relationships of tokens in the follow-up query. The mapping of patterns and tokens into query fragments and the grouping and nesting of the query fragments occurs at 230 and 240 respectively and are performed similarly as discussed above.

The main distinction in the translation method relies in the query context determination at 245. More particularly, for each query in the query tree, a topic of interest, also referred to as a context center, is determined. In various aspects, the context center for the parent query is determined as the lowest noun token among those whose corresponding basic variables are not included in a WHERE clause. If no such noun token exists, then the context center for the parent query is determined as a noun token whose corresponding basic variable is included in a RETURN clause. When a query contains core tokens, the context center of the query can be a core token. In addition, the first core token can be chosen as the context center, as other core tokens are used to specify constraints on the first core token in the form of value join. For example, the context center for the exemplary NLQ discussed above is director (node 7 in FIG. 3), which is the first core token of the query; the other core token (node 11 in FIG. 3) is not the context center.

A child query can inherit or modify the context center of the parent query. For example, as shown in FIG. 12, Q4 specifies the topic of interest to be movies made by a particular director after a certain year; the child query Q4.1 imposes more restrictions over year but is also looking for movies. A child query can be partially specified and contain no context center. For example, the user can specify “But before 2000” as a follow-up query to Q4 in FIG. 12. The only noun token “year” is not a context center as it only appears in a WHERE clause. In such a case, the query simply inherits the context center of the parent query.

As can be appreciated, a child query can also change the context center of the parent query. For example, in FIG. 12, Q5.1 changes the context center from author in Q5 to publisher. Different context centers in the same query tree may simply be viewed as disjunctive objects of interest to the user. For ease of discussion, in the remainder of the disclosure discusses a query tree that includes only one context center at any time.

Query construction is then performed based on the context center at 250. In particular, the context center is used to reformat the structured language query for the parent query based on the terms in the child query. For example, terms in a child query can be used to add new constraints and/or results/sorting specifications to the context center. In various aspects, terms in a child query can be used to specify constraints and results/sorting specifications to replace existing conditions. In various aspects, terms in a child query can be used to change the context center. When a context center is to be replaced by a new context center, any query fragment in the inherited query context that contains the variables unrelated to the new context center is removed from the query. Thereafter, the translation is complete and the method may end at 270.

Referring back to FIG. 1, reference resolution can be an important step in query translation for follow-up queries, where semantic meanings of references to prior queries are identified. In various aspects, the translator 48 can determine the resolution of pronoun anaphora between sentences where the antecedent is a common noun. The classifier classifies common nouns as a reference token (RT). The translator then performs reference resolution by finding the corresponding noun token(s) in the parent query context for a reference token. Appendix J lists exemplary reference resolution definitions. As can be seen, a reference token may refer to multiple antecedents in RETURN clause (e.g., “those” may refers to both “title” and “year”). In addition, since the context center is more likely to be referred to by follow-up queries, higher priority is given to the context center. For example, based on our algorithm, “those” in Q4.2 (FIG. 12) refers to “movies” instead of “titles.” For others, the antecedent can be found by relying on number and gender matches.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, specification, and the following claims.

1. A method for translating a natural language query into a structured query for a database, comprising:
generating a parse tree which represents a natural language query for a database;
mapping terms in the parse tree to components of a structured query language for the database; and
grouping the components of the structured query language.

2. The method of claim 1 wherein the grouping comprises grouping the components of the structured query language based on proximity of the terms in the parse tree which were mapped to components.

3. The method of claim 1 further comprises identifying whether the parse tree can be translated to the structure query language after the step of generating.

4. The method of claim 3 further comprises prompting a system operator to generate a revised natural language query when the parse tree cannot be translated to the structured query language.

5. The method of claim 4 wherein the prompting a system operator includes providing at least one valid option that can be selected by the system operator.

6. The method of claim 1 further comprises identifying whether terms in the parse tree can be found in the database.

7. The method of claim 6 further comprises prompting a system operator to generate a revised natural language query when the term cannot be found in the database.

8. The method of claim 7 wherein the prompting a system operator includes providing at least one valid option that can be selected by the system operator.

9. The method of claim 1 further comprises adaptively learning query information based on previously entered natural language queries.

10. The method of claim 1 further comprises transforming the parse tree based on adaptively learned query information.

11. The method of claim 9 further comprises generating transformation rules that map domain-specific semantics to generic terms based on the adaptively learned query information.

12. The method of claim 11 further comprises compiling a confidence score that establishes priority amongst the transformation rules.

13. The method of claim 12 further comprises transforming the parse tree based on at least one of the transformation rules and the confidence score.

14. The method of claim 1 further comprises nesting the groups of components.

15. The method of claim 1 wherein the mapping terms comprises mapping terms in the parse tree based on a semantic contribution of the term.

16. The method of claim 1 further comprises constructing a structured language query based on the groups of components.

17. The method of claim 1 further comprises associating iterative natural language queries by determining a topic of interest.

18. The method of claim 17 further comprises constructing subsequent structured language queries based on the topic of interest.

19. The method of claim 17 further comprises constructing subsequent structured language queries by combining a grouping of a first natural language query with a grouping of a subsequent, partial natural language query based on the topic of interest.

20. The method of claim 17 further comprising generating a results history tree based on iterative natural language queries.

21. A computer program product for performing natural language queries of a database, the computer program product comprising:
a computer readable medium including:
a parser operable to generate a parse tree which represents a natural language query for a database;
a classifier operable to map terms in the parse tree to components of a structured query language for the database; and
a translator operable to group the components of the structured query language.

22. The computer program product of claim 21 wherein the translator is further operable to group the components of the structured query language based on proximity of the terms in the parse tree which were mapped to components.

23. The computer program product of claim 21 further comprises a validator operable to identify whether the parse tree can be translated to the structured query language.

24. The computer program product of claim 23 wherein the validator is further operable to prompt a system operator to generate a revised natural language query when the parse tree cannot be translated to the structured query language.

25. The computer program product of claim 23 wherein the validator is further operable to provide selectable options to a system operator when the parse tree cannot be translated to the structured query language.

26. The computer program product of claim 21 further comprises a domain adapter operable to transform the parse tree based on learned query information.

27. The computer program product of claim 21 further comprises a knowledge extractor operable to incrementally learn query information based on at least one of previous natural language queries and feedback information entered by a system operator.

28. The computer program product of claim 21 wherein the translator is further operable to nest the groups of components.

29. The computer program product of claim 21 wherein the translator is further operable to construct a structured language query based on the groups of components.

30. The computer program product of claim 21 wherein the translator is further operable to associate iterative natural language queries by determining a topic of interest.

31. The computer program product of claim 30 wherein the iterative natural language queries are partial natural language queries.

32. The computer program product of claim 30 wherein the translator is further operable to construct subsequent structured language queries based on the topic of interest.

33. The computer program product of claim 21 wherein the structured query language includes Extensible Markup Language (XML).

34. A method for translating a natural language query into a structured language query for a database, comprising:
receiving a natural language query for a database;
transforming the natural language query based on incrementally learned information from previous natural language queries; and
translating the transformed natural language query to a structured language query.

35. The method of claim 34 further comprises incrementally learning valid query information based on natural language queries and feedback from a system operator.

36. The method of claim 34 further comprises generating transformation rules that map domain-specific semantics to generic terms based on the incrementally learned query information and wherein the transforming the natural language query is based on the transformation rules.

37. The method of claim 36 further comprises compiling a confidence score that establishes priority amongst the transformation rules.

38. The method of claim 37 further comprises transforming the natural language query based on at least one of the transformation rules and the confidence score.

39. A method for translating a natural language query into a structured language query for a database, comprising:
receiving a natural language query for a database;
translating the natural language query to a structured query language;
receiving a subsequent partial natural language query for the database;
translating the partial natural language query to the structured query language; and
constructing a structured language query by associating the translated natural language query with the translated partial natural language query.

40. The method of claim 39 wherein the constructing comprises constructing the translated natural language query by determining a topic of interest for the translated natural language query and the translated partial natural language query, and associating the translated natural language query with the translated partial natural language query based on the topics of interest.

41. The method of claim 39 wherein the determining the topic of interest is based on a relationship of a noun in the natural language query relative to a structure of the natural language query.

42. The method of claim 39 further comprising generating a results history tree based on query results of the structured language query.
